(19) United States
(12) Patent Application Publication
(10) Pub. No.: US 2003/0137590 A1
(43) Pub. Date: Jul. 24, 2003

(54) Machine vision system with auxiliary video input

(76) Inventors: Danny S. Barnes, Maple Valley, WA (US); Matthew E. Allen, Maple Valley, WA (US); James W. Moore, Renton, WA (US)

Correspondence Address: Todd M. Becker, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/052,649

(22) Filed: Jan. 18, 2002

(51) Int. Cl. H04N 5/228; H04N 5/225

(52) U.S. Cl. 348/222.1; 348/218.1

(57) ABSTRACT

An apparatus is disclosed which includes a machine-vision system comprising an internal camera operatively connected to an image capture unit, and a digital signal processing unit, and a camera port connected to the image capture unit, wherein the port is adapted to allow an external camera to be connected to the machine vision system so that the image capture unit can capture images from both the internal camera and the external camera. Also disclosed is a process, which comprises capturing a first image using a machine vision system comprising an internal camera, an image capture unit, and a digital signal processing unit, storing or processing the first image; capturing a second image using an external camera connected to the image capture unit, and storing or processing the second image.

### TECHNICAL FIELD

This disclosure relates generally to machine vision, and in particular, but not exclusively, relates to a machine vision apparatus including the ability to receive auxiliary video input.

### BACKGROUND

Data acquisition devices have become an important tool in tracking many different types of items. Perhaps the best-known and longest-used type of data acquisition device is the bar-code scanner, which is often used in commercial applications such as grocery stores to identify groceries, in document applications to track documents, and so forth. Bar code scanners typically read and decode a linear bar code, which can either be printed directly on an item of interest or can be printed on a label and then attached to the item. The most familiar type of linear bar code usually consists of a series of black bars of differing widths, spaced apart from each other by white space.

Less well known than linear bar code, but equally if not more important, are two-dimensional codes, also known as “matrix” codes. The two-dimensional code has several advantages over linear code, most important of which are the ability to encode much more information than a linear code, vastly improved data integrity, and occupy far less space. A disadvantage of two-dimensional codes is that they are more difficult to read and decode. Two-dimensional codes are usually read by machine vision scanners, which essentially capture a digital image of the two-dimensional code, and then proceed to analyze that image to extract the information contained in the code.

Machine vision systems are often highly customized—internally and externally—to meet the requirements of the job for which they will be used. Internally, for example, the optics in the system are chosen to fit the positioning requirements of the job: if the system must be positioned very close to a matrix code whose image it must capture, then the optics must have a short focal length so that the system can focus on the code. In another example, if the frequency with which the system must scan codes is high, the system must have the ability to process and store images quickly. Externally, job requirements may also dictate the physical size of the machine-vision system.

The high level of customization of machine-vision systems presents several disadvantages, most important of which is the lack of flexibility. If a manufacturer makes a particular line of small machine-vision systems for use in tight spaces close to the target matrix, then they will be unable to sell to customers that require scanners that are positioned farther from the target matrix. If a customer changes its requirements, such as changing the distance from the system to the target or changing the size of the target, the level of customization will require that they replace their systems, leading to additional expense and downtime. Or, if a customer needs to expand the capabilities of their system, such as expanding its field of view or allowing it to capture images from more than one location simultaneously, then they would have to obtain a new system.

There is thus a need in the art for an apparatus and method to enhance the capabilities and flexibility of a machine vision system without having to replace the system.

### SUMMARY OF THE INVENTION

An apparatus is disclosed which includes a machine-vision system comprising an internal camera operatively connected to an image capture unit, and a digital signal processing unit, and a camera port connected to the image capture unit, wherein the port is adapted to allow an external camera to be connected to the machine vision system so that the image capture unit can capture images from both the internal camera and the external camera. Also disclosed is a process, which comprises capturing a first image using a machine vision system comprising an internal camera, an image capture unit, and a digital signal processing unit, storing or processing the first image; capturing a second image using an external camera connected to the image capture unit, and storing or processing the second image. Finally, a machine vision system is disclosed comprising an internal camera operatively connected to an image capture unit, and a digital signal processing unit. The system further includes a camera port connected to the image capture unit, wherein the port is adapted to allow an external camera to be connected to the machine vision system so that the image capture unit can capture images from both the internal camera and the external camera, and an external camera connected to the camera port.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating the construction and function of a first embodiment of the present invention.

FIG. 2 is a block diagram illustrating the construction and function of a second embodiment of the present invention.

### DETAILED DESCRIPTION OF THE ILLUSTRATED EMBODIMENTS

Embodiments of a machine vision system including auxiliary video input are described herein. In the following description, numerous specific details are described to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in this specification do not necessarily all refer to the same embodiment. Furthermore, the particular features, structures, or characteristics may be combined in any suitable manner in one or more embodiments.

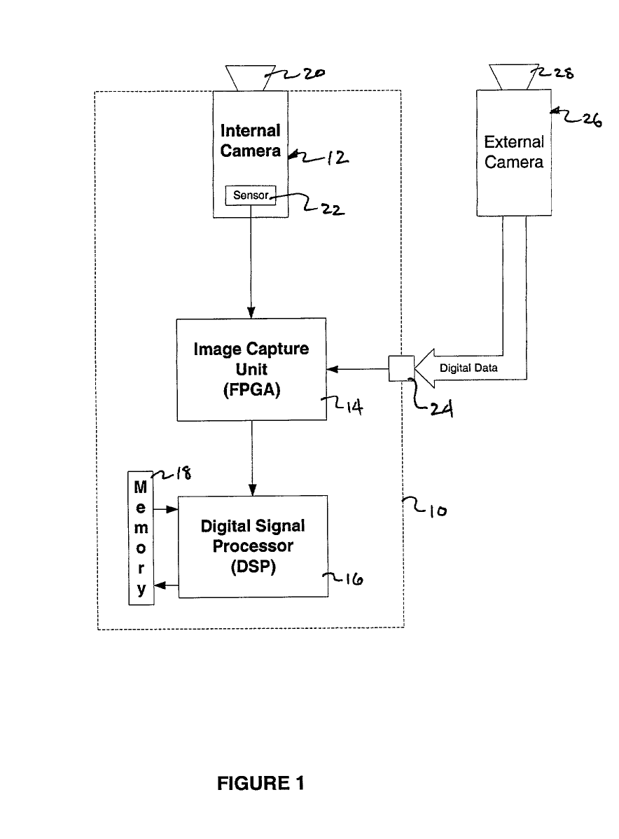

FIG. 1 illustrates a first embodiment of a machine vision system 10 embodying the present invention. The machine vision system 10 comprises three primary components: an internal camera 12, an image capture unit 14, and a digital signal processor (DSP) 16. The internal camera is connected to the image capture unit 14, which is in turn connected to the DSP 16. The machine vision system 10 will also typically include a memory 18 connected to the DSP 16 to store the digital images captured by the image capture unit 14. The digital images are transferred directly from the image capture unit 14 to the DSP 16, and the DSP 16 can either process a received digital image immediately, or can store the image in the memory 18 and retrieve it later for processing. The memory may be any kind of electronic memory, such as RAM, or may be some form of magnetic, optical, or electronic storage.

The internal camera 12 may be any kind of commercially available machine vision camera, and would include, among other things, a lens 20 and an image sensor 22, such as complementary metal oxide semiconductor (CMOS) or charged coupled device (CCD). The lens 20 focuses an image of the target matrix onto the image sensor 22, which then converts the image projected on it into digital information.

Once an image has been digitized by the image sensor in the internal camera 12, the digital information output by the image sensor 22 is sent to an image capture unit 14, also commonly known in the art as a “frame grabber.” The image capture unit 14 comprises, among other things, a field programmable gate array (FPGA) which captures and pre-processes the digital image information being fed to it from the image sensor 22 in the internal camera 12. The image capture unit may include, for example, an FPGA such as a Xilinx model XC2V500, although other FPGAs may be used as well. After pre-processing by the image capture unit 14, the image is passed on to a digital signal processor (DSP) 16 for processing to extract information from the image of the matrix code.

In addition to the components mentioned, the machine vision system 10 also includes a port 24 to which an external camera 26 can be attached. The addition of an external camera adds a vast amount of flexibility to the machine vision system, as it permits the easy addition to the machine vision system 10 of a camera having a different focal length, fields of view, or other characteristics. In the embodiment shown, the external camera is a digital camera, which, like the internal camera 12, is a digital camera including a lens 28 and an image sensor.

When the external camera is connected to the machine vision system 10 through the port 24, the user may specify whether the image capture unit 14 and the digital signal processor 16 will receive images from the internal camera 12, the external camera 26, or both. Generally, the FPGA in the image capture unit 14 controls switching between the internal camera and the external camera, based on user instructions. If the FPGA, the memory 18, and the system bus have sufficient capability, the image capture unit can process images from both cameras in parallel—in other words, it can simultaneously capture images from both cameras. Alternatively, if a user wants images from both cameras, the FPGA can switch between the internal camera 12 and the external camera 26, and vice versa, between frames. When the image capture unit 14 receives alternating images from both the internal camera and the external camera, a user can instruct the system as to how they want the images sequenced. For example, a user can specify that the FPGA alternate between cameras every frame or, alternatively, the user can specify that the image capture unit 14 should capture an integral number of images (greater than 1) from one camera before capturing any images from the other. The user may also specify the interval between frame captures for each individual camera.

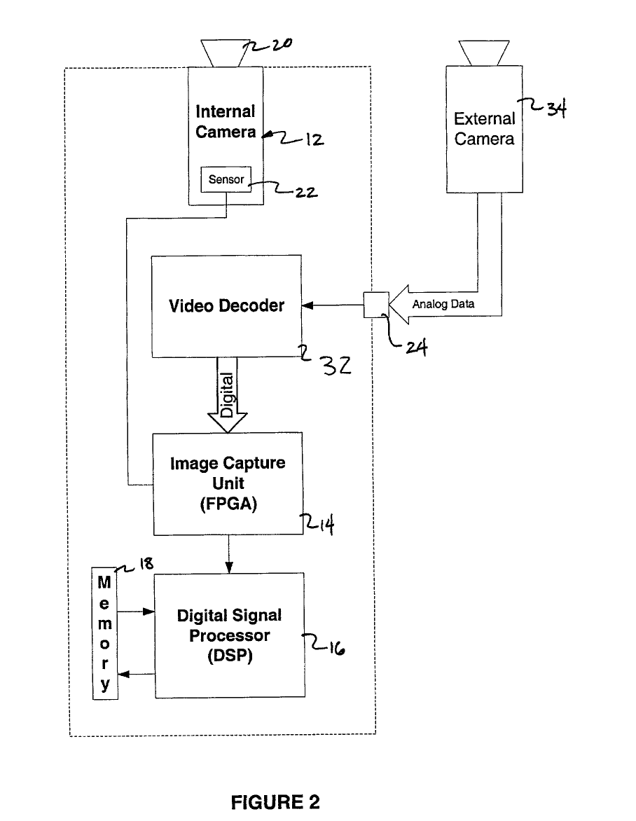

FIG. 2 illustrates an alternative embodiment 30 that incorporates the present invention in a machine-vision system. The machine vision system 30 comprises three primary components: an internal camera 12, an image capture unit 14, and a digital signal processor (DSP) 16. The internal camera is connected to the image capture unit 14, which is in turn connected to the DSP 16. The machine vision system 30 also typically includes a memory 18 connected to the DSP 16 to store the digital images captured by the image capture unit 14. The digital images are transferred directly from the image capture unit 14 to the DSP 16, and the DSP 16 can either process a received digital image immediately, or can store the image in the memory 18 and retrieve it later for processing. The memory may be any kind of electronic memory, such as RAM, or may be some form of magnetic, optical, or electronic storage. In this embodiment, a video decoder 32 is also included in the system. The video decoder is connected to the image capture unit 14, to which it sends 10-bit digital data. The video decoder 32 is also connected to a port 24 to which an external video camera 34 can be connected.

In operation, the internal camera 12 captures an image on its image sensor and the image sensor then sends the image data to the image capture unit 14. The image capture unit takes the data from the image sensor and pre-processes it to convert it to a digital format suitable for processing by the digital signal processor 16. The image capture unit then transfers the digital information to the digital signal processor 16 for processing.

When the external camera 34 is attached to the machine vision system, the external camera, which in this embodiment is an analog camera, transmits analog video data, for example RS-170 format video, to the video decoder 32 via the port 24. The RS-170 format video used in the present system is preferably progressive (i.e., not interlaced) video. The video decoder receives the information fed from the external camera 34, and converts it into a digital format, for example a 10-bit digital format. As the video decoder decodes the analog image it has received, it transfers the digital image information to the image capture unit 14, for pre-processing. The image capture unit 14 then transfers the image data to the digital signal processor 16 for processing.

As with the previous embodiment, when the external camera 34 is connected to the machine vision system 10 through the port 24, the user may specify whether the image capture unit 14 and the digital signal processor 16 will receive images from the internal camera 12, the external camera 34, or both. Generally, the FPGA in the image capture unit 14 controls switching between the internal camera and the external camera, based on user instructions. If the FPGA, the memory 18, the video decoder 32, and the system bus have sufficient capability, the image capture unit can process images from both cameras in parallel—in other words, it can simultaneously capture images from both cameras. Alternatively, if a user wants images from both cameras, the FPGA can switch between the internal camera 12 and the external camera 34, and vice versa, between frames. When the image capture unit 14 receives alternating images from both the internal camera and the external camera, a user can instruct the system as to how they want the images sequenced. For example, a user can specify that the FPGA alternate between cameras every frame or, alternatively, the user can specify that the image capture unit 14 should capture an integral number of images (greater than 1) from one camera before capturing any images from the other. The user may also specify the interval between frame captures for each individual camera.

The ability to add an external camera to a machine vision system, as described in both embodiments above, confers significant advantages to both system manufacturers and customers. The ability to add an external camera to the system frees the manufacturer from the shackles of customization, and allows them to vastly expand the range and capability of their scanners. For the customer, the ability to add an external camera to a fully operational scanning unit reduces cost and increases flexibility. System characteristics are now easily changed, simply by the addition of a suitable camera: it's the system's focal length, field of view, etc are now all changeable. Moreover, since the system has the ability to use both its internal and external cameras, a single vision system can now be easily converted for uses that previously required two. For example, if matrix codes appeared on both sides of an item, two systems would be needed—one for each side. With the ability to add an external camera to a fully functional vision system, a single vision system can now be used to scan both sides of the item.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. An apparatus comprising:
a machine-vision system comprising an internal camera operatively connected to an image capture unit, and a digital signal processing unit; and
a camera port connected to the image capture unit, wherein the port is adapted to allow an external camera to be connected to the machine vision system so that the image capture unit can capture images from both the internal camera and the external camera.

2. The apparatus of claim 1,further comprising an external camera, wherein the external camera outputs a digital signal.

3. The apparatus of claim 1, further comprising a decoder connected to the camera port and to the image capture unit.

4. The apparatus of claim 3, further comprising an external camera, wherein the external camera outputs an analog signal.

5. The apparatus of claim 1 wherein the internal camera comprises a lens and an image sensor.

6. The apparatus of claim 1, further comprising a memory.

7. A process comprising:
capturing a first image using a machine vision system comprising an internal camera, an image capture unit, and a digital signal processing unit;
storing or processing the first image;
capturing a second image using an external camera connected to the image capture unit; and
storing or processing the second image.

8. The process of claim 7 wherein the internal camera outputs a digital signal.

9. The process of claim 7 wherein the external camera outputs an analog signal, and further comprising converting the analog signal into a digital signal.

10. A machine-vision system comprising:
an internal camera operatively connected to an image capture unit, and a digital signal processing unit;
a camera port connected to the image capture unit, wherein the port is adapted to allow an external camera to be connected to the machine vision system so that the image capture unit can capture images from both the internal camera and the external camera; and
an external camera connected to the camera port.

11. The apparatus of claim 10 wherein the internal camera comprises a lens and an image sensor.

12. The apparatus of claim 11 wherein the internal camera outputs a digital signal.

13. The apparatus of claim 10, further comprising a decoder connected to the camera port and to the image capture unit.

14. The apparatus of claim 13 wherein the external camera outputs an analog signal.
